(19) United States
(12) Patent Application Publication
(10) Pub. No.: US 2020/0126066 A1
(43) Pub. Date: Apr. 23, 2020

(54) CARD-PAYMENT-SYSTEM BACK-UP PROCESSING FOR FAILED REAL-TIME PAYMENT SYSTEM TRANSACTION

(71) Applicant: Mastercard International Incorporated, Purchase, NY (US)

(72) Inventors: Irina Singh, White Plains, NY (US); Sandeep Malhotra, Greenwich, CT (US); Shanthan Subramaniam, Baldwin Place, NY (US)

(21) Appl. No.: 16/656,078

(22) Filed: Oct. 17, 2019

Related U.S. Application Data
(60) Provisional application No. 62/747,422, filed on Oct. 18, 2018.

(51) Int. Cl. G06Q 20/34; G06Q 20/26

(52) U.S. Cl. CPC G06Q 20/34; G06Q 20/26

(57) ABSTRACT

A real-time payment system transaction is initiated to settle a purchase of goods or services. An indication is received that the real-time payment system transaction failed. In response to the indication, the purchase of goods or services is settled via a settlement system associated with a payment card account system.

### CROSS REFERENCE TO RELATED APPLICATION

This application claims the benefit of U.S. Provisional Patent Application No. 62/747,422 (filed on Oct. 18, 2018); the contents of which provisional application are hereby incorporated by reference for all purposes.

### BACKGROUND

FIG. 1 is a block diagram that illustrates a conventional payment card account system 100.

The system 100 includes a customer device 102 such as a magnetic stripe card, a payment IC (integrated circuit) card (contactless and/or contact), or a payment-enabled mobile device. Block 104 in FIG. 1 represents a merchant device such as a POS (point of sale) terminal/card reader. The merchant device 104 may also be considered part of the payment card account system 100. The customer device 102 may be presented to the merchant device 104, to consummate a purchase transaction and to permit the merchant device 104 to read payment card account data (including, e.g., a payment account number or payment token) from the customer device 102. In other situations, the merchant device 104 may be an e-commerce server computer, and the customer device 102 may be a personal computer, a mobile device running a mobile browser, etc.; in such situations, the customer device 102 may engage in an online shopping session with an e-commerce website hosted by the merchant device 104.

A computer 106 operated by an acquirer (acquiring financial institution) is also shown as part of the system 100 in FIG. 1. The acquirer computer 106 may receive a payment account system authorization request message for the transaction from the merchant device 104. The acquirer computer 106 may route the authorization request message via a payment card network 108 to a server computer 110 operated by the issuer (also referred to as the “issuer bank”) of a payment account that is associated with the account number obtained by the merchant device 104 (e.g., from the customer device 102) and included in the authorization request message. The authorization response message generated by the payment account issuer server computer 110 may be routed back to the merchant device 104 via the payment card network 108 and the acquirer computer 106.

One well known example of a card network is the network operated by Mastercard International Incorporated, which is the assignee hereof.

The payment account issuer server computer 110 may be operated by or on behalf of a financial institution (“FI”) that issues payment accounts to individual users such as the customer who presented or operated the customer device 102 referred to above. For example, the payment card issuer server computer 110 may perform such functions as (a) receiving and responding to requests for authorization of payment account transactions to be charged to payment accounts issued by the FI; and (b) tracking and storing transactions and maintaining account records.

Generally within two or three days after the authorization request and response messaging, the transaction is cleared via settlement between the issuer and the acquirer via a settlement system (not shown in FIG. 1) that is associated with and operated under the auspices of the payment card network 108.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their devices, as well as a very large number of customer devices.

Other types of payment systems exist besides payment card account systems of the type illustrated in FIG. 1. For example, there are currently in operation around the world more than two dozen so-called “real-time payment systems.” In such systems, a payment transaction may be initiated and completed within a time span of a few minutes or less up to about a few hours. Examples of such systems include UPI/IMPS in India, Zengin in Japan and FPS in the United Kingdom. These real-time payment systems have central infrastructure, which clears and posts transactions to beneficiary bank accounts. However, in many such systems, a small proportion of transactions fail but such failures are not rare. In some real-time payment systems, the failure rate for transactions may run at about 5%. The structure of real-time payment systems includes asynchronous messaging such that failure of a transaction may not be signaled until after a considerable lapse of time. This drawback of real-time payment systems has generally been regarded as making them unsuitable for use at the point of sale for purchase transactions between a customer/consumer and a merchant. Absent this drawback, real-time payment systems would present desirable features, such as more rapid access to purchase transaction proceeds for merchants and use by consumers who lack creditworthiness.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments, and which are not necessarily drawn to scale, wherein:

FIG. 1 is a block diagram of a conventional payment card network arrangement.

FIG. 2 is a block diagram of a payment system provided according to aspects of the present disclosure.

FIGS. 3 and 4 are respectively block diagram illustrations of computer systems that may play a role in the payment system of FIG. 2.

FIGS. 5A and 5B together form a flow chart that illustrates a process that may be performed in the system of FIG. 2 in accordance with aspects of the present disclosure.

### DESCRIPTION

In general, and for the purpose of introducing concepts of embodiments of the present disclosure, according to a payment system disclosed herein, in ordinary course, merchants are paid for purchases via a real-time payment system. In the payment system disclosed herein, when a real-time payment system transaction fails, funds are transferred to the merchant through the intervention of a payment card account system and clearing/settlement of the transaction occurs via the settlement system associated with the payment card account system.

With this arrangement, because the real-time payment system is backed up by a payment card account system, the reliability of the overall system is sufficient to allow real-time payment transactions to be the normal mode of payment to the merchant With real-time payment transactions, the merchant receives the funds arising from a purchase transaction more rapidly than with conventional payment card account system settlement transactions. At the same time, consumers may be enabled to perform cashless transactions even if they are not creditworthy enough to be provided with credit card accounts, and consumers need not open an account other than a bank account.

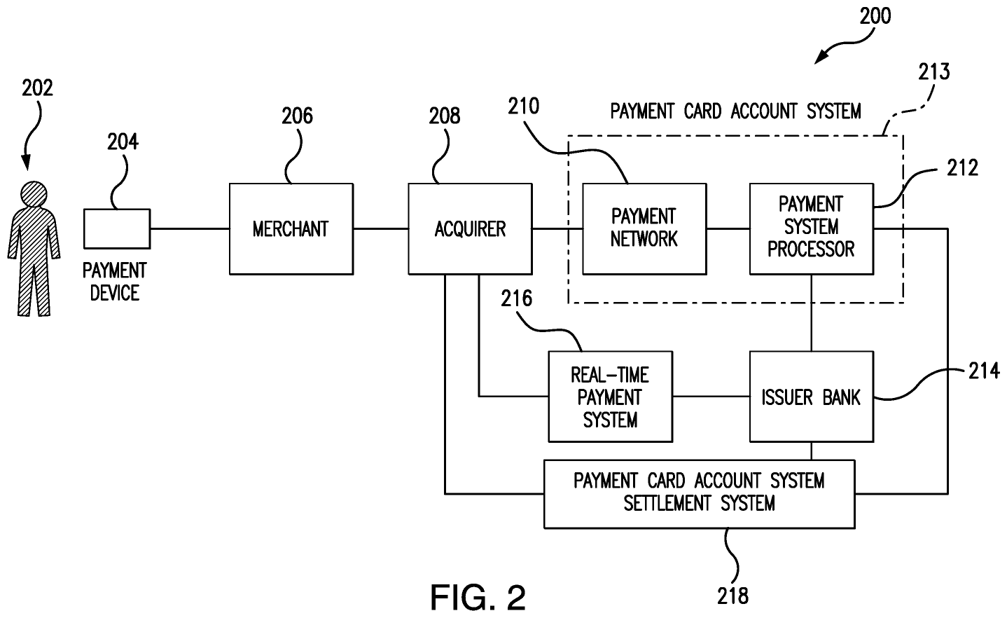

FIG. 2 is a block diagram of a payment system 200 according to some embodiments. FIG. 2 illustrates entities/devices involved in a typical transaction performed according to aspects of the present disclosure.

A customer/user/consumer of the payment system 200 is shown at 202, presenting a payment device 204 (IC payment card, magnetic stripe payment card, payment-enabled mobile device, for example) to a merchant 206. In the case of a payment-enabled mobile device, the device may run a payment app and may have been provisioned with a payment token that represents the consumer's bank account. The merchant 206 is in communication with the merchant's acquirer FI 208. The acquirer 208 routes the transaction to the payment network 210 (also referred to as a “payment card network” or a “card network”). A payment system processor 212 is in cooperative communication with the payment network 210. As indicated by a dot-dash box 213, the payment network 210 and the payment system processor 212 may be under common control and operation and may constitute major components of a payment card account system, which shares the reference 213 with the dot-dash box. The payment system processor 212 is shown in communication with the user's issuer FI 214, which is also referred to as the “consumer's bank” or simply the “issuer.” The issuer 214 is in communication with a real-time payment system 216, which is operative to effect funds transfers from the issuer 214 to the acquirer 208 for the benefit of the merchant 206 and chargeable to the consumer 202. It will be appreciated that the acquirer is a bank that serves the merchant with payment acceptance services, and the merchant is a provider of goods and/or services to the consumer.

The payment system 200 also includes a payment card account system settlement system 218. As will be seen, the payment card account system settlement system 218 may implement instructions from the payment system processor 212 to settle payment transactions in cases where a real-time payment system transaction has failed. In terms of its internal functions and capabilities, the payment card account system settlement system 218 need not differ from conventional settlement systems associated with payment card account systems. As is customary, the payment card account system settlement system 218 may operate to transfer funds from the issuer 214 to the acquirer 208.

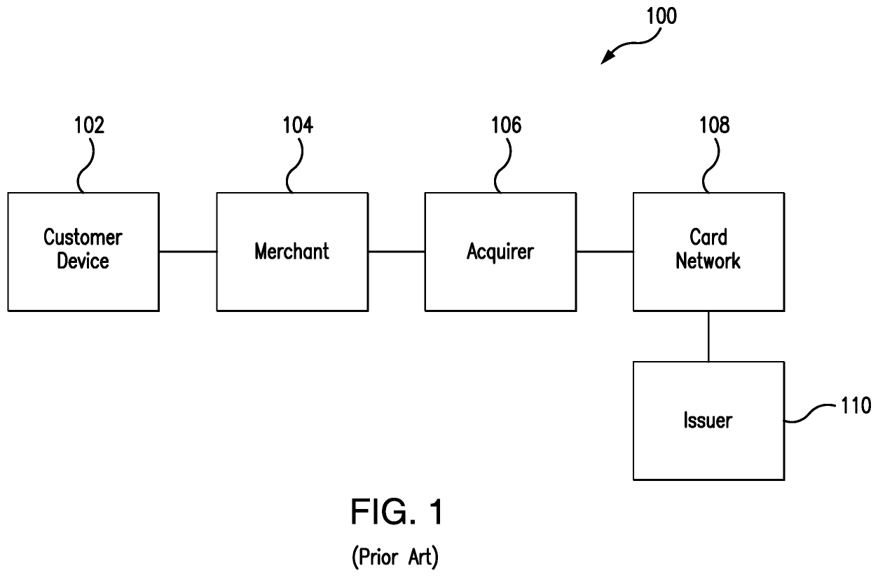

The payment system 200 may also, in some embodiments, have all of the capabilities of a conventional payment card account system, such as that described above in connection with FIG. 1.

Each block in FIG. 2 that represents an entity should also be understood to represent one or more computers operated by or on behalf of that entity.

The payment system 200 is illustrated in FIG. 2 in the context of a single transaction. However, in a practical embodiment of the payment system 200, it may handle numerous transactions, including numerous simultaneous transactions. The system 200 may include many other issuers and acquirers besides those shown in FIG. 2. Many merchants may participate in the payment system 200, as may numerous holders of payment card system accounts and/or bank deposit accounts.

In the example transaction of FIG. 2, it is assumed that the acceptance of the payment transaction occurs at the point of sale in a retail store. Alternatively, however, the transaction may arise from an online purchase, implemented through an e-commerce website operated by the merchant 206.

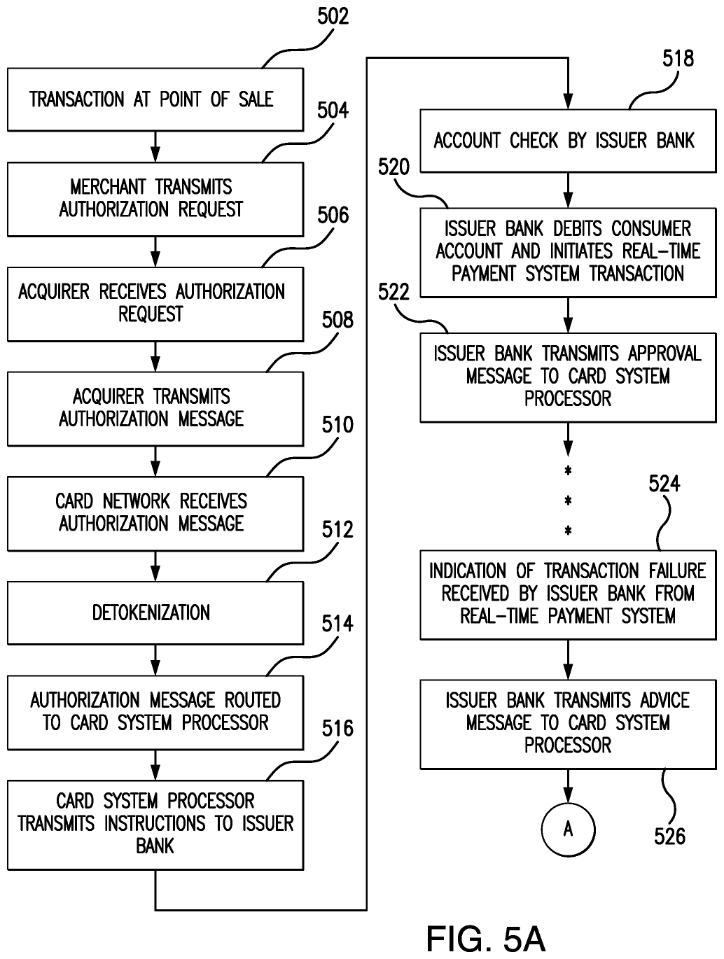

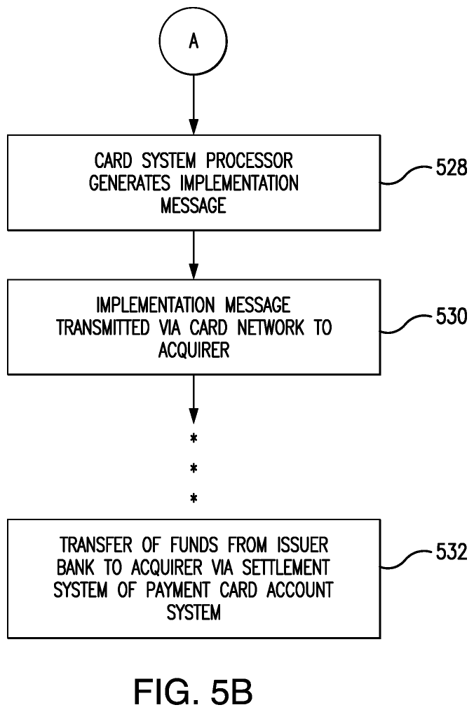

An example of operation of the payment system 200 will be described below, particularly with reference to FIGS. 5A and 5B. First, though, there will be a further description of some components of the payment system 200.

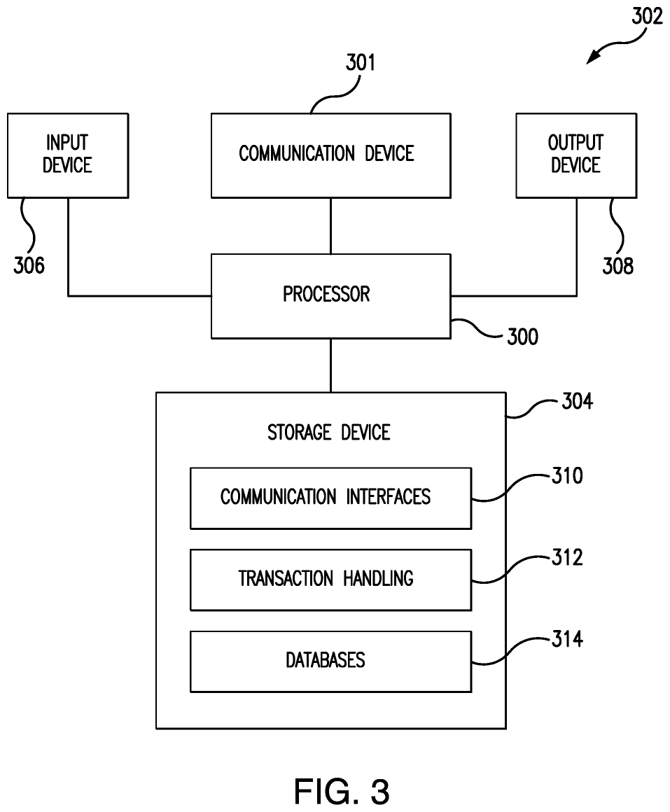

FIG. 3 is a block diagram that illustrates an example embodiment of a computer system 302 that may implement functions performed by or on behalf of the issuer 214. The computer 302 will therefore be referred to as the “issuer computer.” The issuer computer 302 may, in its hardware aspects, resemble a typical mainframe or server computer, but may be controlled by software to cause it to function as described herein.

Referring to FIG. 3, the issuer computer 302 may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more processors. Processor 300 operates to execute processor-executable steps, contained in program instructions described below, so as to control the issuer computer 302 to provide desired functionality.

Communication device 301 may be used to facilitate communication with, for example, other devices such as computers operated by or on behalf of the payment card account system 213 and the real-time payment system 216. Communication device 301 may comprise numerous communication ports (not separately shown), to allow the issuer computer 302 to communicate simultaneously with a considerable number of other computers, and/or to simultaneously handle numerous transactions.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the issuer computer 302, executed by the processor 300 to cause the issuer computer 302 to function as described herein.

The programs may include one or more conventional operating systems (not shown) that control the processor 300 so as to manage and coordinate activities and sharing of resources in the issuer computer 302, and to serve as a host for application programs (described below) that run on the issuer computer 302.

The storage device 304 may also store communication software interfaces 310. The communication software interfaces 310 may control the issuer computer 302 to facilitate communication between the issuer computer 302 and other computers.

The storage device 304 may in addition store a transaction handling application program 312. The transaction handling application program 312 may control the processor 300 to cause the issuer computer 302 to perform functions required to execute transactions involving the issuer 214. Details of some aspects of the operation of the transaction handling application program 312 are discussed below in connection with FIGS. 5A and 5B.

Continuing to refer to FIG. 3, the storage device 304 may also store, and issuer computer 302 may also execute, other programs, which are not shown. For example, such programs may include a reporting application. The latter program may respond to requests from system administrators for reports on the activities performed by the issuer computer 302. The other programs may also include, e.g., device drivers, database management software, etc.

Moreover, the storage device 304 may also store one or more databases 314 needed for operation of the issuer computer 302.

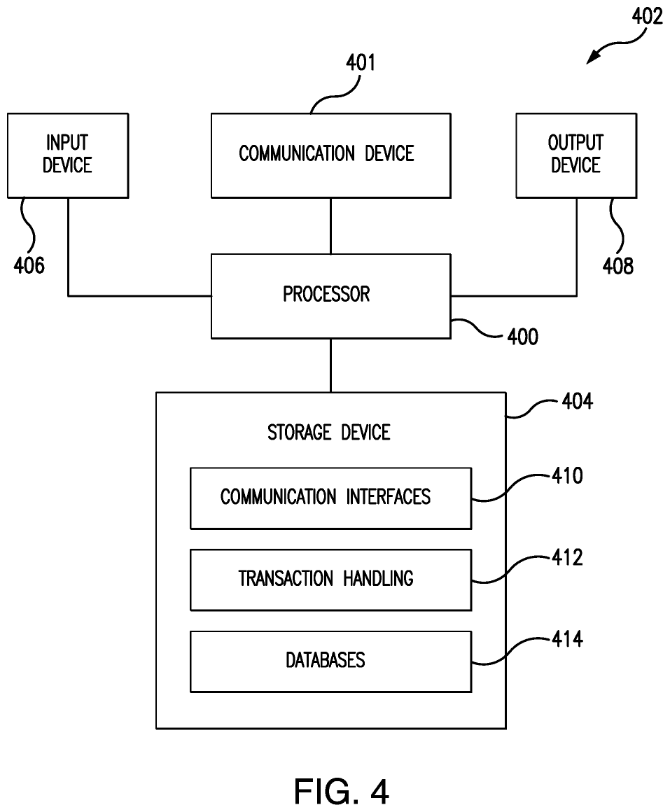

FIG. 4 is a block diagram that illustrates an example embodiment of a computer system 402 operated to implement functions of the payment system processor 212 shown in FIG. 2. The computer system 402 will hereinafter be referred to as the “payment system processor computer.” The payment system processor computer 402 may have the same type of architecture and may feature the same types of components as discussed above in connection with FIG. 3. Referring to FIG. 4, the payment system processor computer 402 may include a computer processor 400 operatively coupled to a communication device 401, a storage device 404, an input device 406 and an output device 408. The communications device 401, the storage device 404, the input device 406 and the output device 408 may all be in communication with the processor 400.

Storage device 404 stores one or more programs for controlling processor 400. The programs comprise program instructions (which may be referred to as computer readable program code means) that contain processor-executable process steps of the payment system processor computer 402 executed by the processor 400 to cause the payment system processor computer 402 to function as described herein.

The programs may include one or more conventional operating systems (not shown) that control the processor 400 so as to manage and coordinate activities and sharing of resources in the payment system processor computer 402, and to serve as a host for application programs (described below) that run on the payment system processor computer 402.

The storage device 404 may also store communication software interfaces 410. The communication software interfaces 410 may control the payment system processor computer 402 to facilitate communication between the payment system processor computer 402 and other computers.

The storage device 404 may in addition store a transaction handling application program 412. The transaction handling application program 412 may control the processor 400 to cause the payment system processor computer 402 to perform functions required to execute transactions involving the payment card account system 213. Details of some aspects of the operation of the transaction handling application program 412 are discussed below in connection with FIGS. 5A and 5B.

The storage device 404 may also store, and the payment system processor computer 402 may also execute, other programs, which are not shown. For example, such programs may include a reporting application. The latter program may respond to requests from system administrators for reports on the activities performed by the payment system processor computer 402. The other programs may also include, e.g., device drivers, database management software, etc.

Moreover, the storage device 404 may store one or more databases 414 needed for operation of the payment system processor computer 402.

Other computer components of the payment system 200 of FIG. 2 may have a similar architecture and/or similar components as were described in connection with FIGS. 3 and 4.

FIGS. 5A and 5B together form a flow chart that illustrates an example of a process that may be performed in the payment system 200 of FIG. 2, according to aspects of the present disclosure.

The ensuing discussion of FIGS. 5A/5B assumes that the merchant, the acquirer and the issuer have each opted for payments for purchase transactions to be handled in the ordinary course via the real-time payment system 216, with the payment card account system settlement system as a back-up in case of failure of the real-time payment system transaction. It is also assumed that the acquirer and the issuer are participants in the real-time payment system 216.

At block 502 in FIG. 5A, a purchase transaction involving the merchant 206 occurs at the point of sale. For example, the consumer 202 may use a payment-enabled mobile device to communicate a payment token to the merchant's POS device (not separately shown). The payment token may be in the form of a payment card account system account number and may represent the consumer's bank account maintained at the issuer 214. The merchant's POS device may, in some instances, also be a mobile device, programmed with a suitable app to allow it to accept payment transactions.

The subject of the purchase transaction is assumed to be one or more items of goods and services, which the merchant provides to the consumer.

Alternatively, the purchase transaction may be an e-commerce transaction.

At 504 in FIG. 5A, the merchant transmits a transaction request message to the acquirer. In some embodiments, this message may take the form of a transaction authorization request message as in the format for payment card account system messaging. The transaction request message may contain a payment token provided to the merchant by the consumer. At 506, the acquirer receives the transaction request message.

At 508 in FIG. 5A, the acquirer transmits a transaction authorization message to the payment network. This message as well may be in the format for payment card account system messaging and may contain the consumer's payment token forwarded by the merchant.

At 510 in FIG. 5A, the payment network receives the transaction authorization message transmitted at 508.

At 512, detokenization occurs. That is, for example, the consumer's bank account number is looked up using the payment token. It is to be noted that detokenization may alternatively occur at a different stage of the transaction handling process from that shown in FIG. 5A.

At 514 in FIG. 5A, the authorization message is routed to the payment system processor 212 (also referred to as the “card system processor”). At 516, the payment system processor 212 transmits a message of instructions to the issuer 214. The instructions direct the issuer 214 to debit the consumer's account maintained for the consumer at the issuer 214, and to credit the transaction amount to the merchant's account (at the acquirer 208) via the real-time payment system 216. It is to be assumed that the instructions message transmitted at 516 is received by the issuer 214.

At 518 in FIG. 5A, the issuer 214 checks the consumer's account to confirm that is holds sufficient funds to support the proposed debit and to otherwise confirm that the consumer and the account are in good standing.

At 520 in FIG. 5A, the issuer 214 debits the transaction amount from the consumer's bank account and initiates a transaction in the real-time payment system 216 to transfer the transaction amount to the acquirer 208 for the benefit of the merchant.

At 522 in FIG. 5A, the issuer 214 transmits a transaction approval message to the payment system processor 212 for routing to the acquirer 208. It can be assumed that the approval message is received by the payment system processor 212, and that the approval or an indication thereof is routed from the payment system processor 212 via the payment network 210 to the acquirer 208, and then from the acquirer to the merchant. As routed through the payment network, the approval may be in the form of a transaction authorization response message. At this point, for those individuals at the point of sale, the transaction is complete, and the consumer is free to depart the point of sale with the purchased item or items (if applicable).

In the usual case where the issuer rapidly (say, within 3 to 4 seconds) receives an indication that the real-time payment system transaction was successfully executed (i.e., contrary to assumptions which underlie the process as presented in FIGS. 5A/5B), then the payment transaction process may end with step 522. However, to the contrary, it is assumed that with perhaps some lapse of time following step 522, the issuer 214 (as indicated at step 524 in FIG. 5A) receives an indication from the real-time payment system 216 that the real-time payment system transaction initiated at 520 has failed. In response to that indication, the issuer (as indicated at step 526 in FIG. 5A) transmits an advice message via the payment card account system 213 to the payment system processor 212. The advice message indicates that the merchant (who was not paid via the real-time payment system 216) is to be credited with the transaction amount via operation of the payment card account system 213. It may be assumed that the payment system processor 212 receives the advice message transmitted from the issuer 214.

Turning now to FIG. 5B, the discussion of the process continues. At 528 in FIG. 5B, the payment system processor 212 generates a suitable message to implement the advice message. In some embodiments, a known message type (such as the message type referred to as a “Fee Collection” message) may be repurposed for implementing the advice message. At 530, the message generated at 528 is transmitted via the payment network 210 to the acquirer 208.

Thereafter, as indicated at 532 in FIG. 5B, the payment indicated by the message generated at 528 and transmitted at 530 is accomplished via the normal settlement process associated with payment card account system transactions and is carried out via the payment card account system settlement system 218. As a result of this settlement activity, the transaction amount is transferred from the issuer 214 to the acquirer 208. In terms of timing, the settlement activity may occur on the usual time scale for operation of a payment card account system, say, one or two days or later after the steps which occurred at 502 to 530. Consequently, when the real-time payment system transaction fails (as assumed to be the case in the process of FIGS. 5A/5B) the merchant does not have access to the purchase transaction proceeds until settlement via the payment card account system settlement system 218 occurs; by contrast, when the real-time payment system transaction succeeds, the merchant enjoys access to the purchase transaction proceeds in “real time.”

To elaborate on timing considerations relative to steps 522 and 524, if there is an indication that the real-time payment system transaction was successful, and such indication arrives within say, 3 to 4 seconds (in some embodiments), then steps 524 et seq. do not occur. Otherwise, the issuer 214 may wait for a response from the real-time payment system 216 for, in some embodiments, up to 2 minutes or 2 hours, or for however long is a customary time to await a response. If the response, when received, indicates that the real-time payment system transaction was successful, then the issuer 214 notifies the payment system processor 212 to indicate that the real-time payment system transaction was successful, and that settlement via the payment card account system settlement system is not needed. If the response, when received, indicates that the real-time payment system transaction failed, then steps 524 through 532 are performed in full.

With a payment system such as is depicted as in FIG. 2 and a process as depicted in FIGS. 5A/5B, a reliable backup mechanism is provided to make up for the unreliability that may be present in execution of real-time payment system transactions. Consequently, and with this backup mechanism, real-time payment system transactions may be suitable for use in purchase transaction situations, such that the merchant ordinarily enjoys real-time access to the proceeds of purchase transactions, and the consumer only needs a bank account (with a participating bank) to make cashless purchases.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The above descriptions and illustrations of processes herein should not be considered to imply a fixed order for performing the process steps. Rather, the process steps may be performed in any order that is practicable, including simultaneous performance of at least some steps and/or omission of steps. For example, in FIG. 5A, step 522 is depicted as following step 520, but in other embodiments, the order of these steps may be reversed.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” or “payment account system” or “payment card account system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific example embodiments, it should be understood that various changes, substitutions, and alterations apparent to those skilled in the art can be made to the disclosed embodiments without departing from the spirit and scope of the appended claims.

What is claimed is:

1. A method comprising:
initiating a real-time payment system transaction to settle a purchase of goods or services;
receiving an indication that the initiated real-time payment system transaction failed; and
in response to said indication, settling the purchase of goods or services via a settlement system associated with a payment card account system.

2. The method of claim 1, further comprising:
prior to the initiating step, receiving an instruction to perform said initiating step.

3. The method of claim 2, wherein said instruction is received from the payment card account system.

4. The method of claim 3, further comprising:
after receiving said instruction and before said initiating step, checking a status of an account to be charged for the real-time payment system transaction.

5. The method of claim 4, wherein said account is debited for said settling via the settlement system associated with the payment card account system.

6. The method of claim 5, further comprising:
routing a transaction approval message to a bank that services a provider of the goods or services.

7. The method of claim 6, wherein said routing step is performed after said initiating step and before said step of receiving an indication that the initiated real-time payment system transaction has failed.

8. The method of claim 6, wherein said routing step is performed after the step of checking the status of the account to be charged for the real-time payment system transaction and before said initiating step.

9. The method of claim 6, wherein said settling the purchase of goods or services via the settlement system associated with the payment card account system includes transmitting an advice message via the payment card account system, said advice message for crediting a transaction amount to the provider of the goods or services.

10. A method comprising:
receiving an instruction from a payment card account system to debit a consumer bank account and credit an account belonging to the merchant;
checking a status of the consumer bank account;
debiting a transaction amount from the consumer bank account;
initiating a real-time payment system transaction to credit the transaction amount to the merchant;
routing a transaction approval message to a bank that serves the merchant;
receiving an indication that the initiated real-time payment system transaction failed;
in response to said indication, transmitting an advice message via the payment card account system; said advice message for crediting the transaction amount to the merchant; and
transferring the transaction amount to the bank that services the merchant, said transferring performed in a transaction settlement system associated with the payment card account system.

11. The method of claim 10, wherein said initiating step is performed before said routing step.

12. The method of claim 10, wherein said routing step is performed before said initiating step.

13. A method comprising:
receiving a transaction request message via a payment card account system;
transmitting an instruction from the payment card account system to a consumer's bank, said instruction directing the consumer's bank to debit an account maintained for the consumer at the consumer's bank and to credit a transaction amount to a merchant's account via a real-time payment system;
receiving an approval message from the consumer's bank;
receiving an advice message from the consumer's bank, the advice message requesting that the transaction amount be credited to the merchant's account via the payment card account system;
generating a transaction information message for implementing the advice message;
transmitting the transaction implementation message to a bank that serves the merchant; and
transferring the transaction amount from the consumer's bank to the bank that serves the merchant, said transferring performed in a transaction settlement system associated with the payment card account system.

14. The method of claim 13, wherein said transaction request message is received from the bank that serves the merchant.

15. The method of claim 14, further comprising:
after said receiving the approval message, routing an authorization response message via the payment card account system to the bank that serves the merchant.

16. The method of claim 15, wherein the authorization response message indicates transaction approval.

17. The method of claim 16, wherein said transferring the transaction amount occurs at least one day after said receiving the transaction request message.

18. The method of claim 17, wherein said transferring the transaction amount occurs two days after said receiving the transaction request message.

19. The method of claim 18, wherein the transaction request message includes a payment token that represents the account maintained for the consumer at the consumer's bank.

20. The method of claim 19, further comprising:
after said receiving the transaction request message, detokenizing the payment token.
